(19) United States
(12) Patent Application Publication
(10) Pub. No.: US 2006/0060426 A1
(43) Pub. Date: Mar. 23, 2006

(54) Lubricant gun

(76) Inventor: Li-Chi Chen, Taichung Hsien (TW)

Correspondence Address: Albert Wai-Kit Chan;Law Offices of Albert Wai-Kit Chan, LLC, World Plaza, Suite 604, 141-07 20th Avenue, Whitestone, NY, 11357, US

(21) Appl. No.: 10/996,752

(22) Filed: Nov. 24, 2004

(30) Foreign Application Priority Data
Sep. 23, 2004 (TW) 093128842

(51) Int. Cl. F16N 21/00

(52) U.S. Cl. 184/105.2

(57) ABSTRACT

A lubricant gun includes a housing, a lubricant reservoir, a plunger, and an exhaust valve. The housing includes a discharge spout, a slide channel fluidly communicated with the discharge spout, a lubricant supply passage having a lubricant supply hole fluidly connected to the slide channel, and a gas-discharging hole fluidly communicated with the slide channel. The lubricant reservoir is connected to the housing and is fluidly communicated with the slide channel through the lubricant supply passage and the lubricant supply hole. The plunger has a pushing portion received in the slide channel for sliding reciprocatingly therein. The exhaust valve is mounted on the housing and is fluidly communicated with the gas-discharging hole.

### CROSS-REFERENCE TO RELATED APPLICATION

This application claims priority of Taiwanese application No. 093128842, filed on Sep. 23, 2004.

### BACKGROUND OF THE INVENTION

1. Field of the Invention

The invention relates to a lubricant gun, more particularly to a lubricant gun capable of discharging gas effectively.

2. Description of the Related Art

Referring to FIGS. 1, 2 and 3, a conventional battery-operated lubricant gun includes a housing 1, a lubricant reservoir 2, an electric motor 3, a power transmission 4, a plunger 5, and an exhaust valve 6. The housing 1 has a discharge spout 101, a slide channel 102 extending along an axial direction and fluidly communicated with the discharge spout 101, a lubricant supply passage 103 fluidly communicated with the slide channel 102, a lubricant supply hole 104 fluidly connected to the lubricant supply passage 103 and the slide channel 102, and a gas-discharging hole 105. The lubricant reservoir 2 is connected to the lubricant supply passage 103, and supplies lubricant to the slide channel 102 through the lubricant supply hole 104. The electric motor 3 is mounted within the housing 1. The power transmission 4 is driven by the electric motor 3. The plunger 5 is driven by the power transmission 4 to reciprocate in the slide channel 102. The exhaust valve 6 includes a hollow valve body 601 mounted on the housing 1 and defining an exhaust hole 6011 communicated with the gas-discharging hole 105, a plug 602 mounted movably within the exhaust hole 6011 and loaded with a spring 603, and a leak-proof ring 604 attached to the bottom of the plug 602.

When the electric motor 3 is activated, the power transmission 4 drives the plunger 5 to move reciprocatingly in the slide channel 102 along the axial direction. The reciprocating movement of the plunger 5 enables the lubricant within the slide channel 102 to be pushed by a front portion 51 of the plunger 5 and to be discharged through the discharge spout 101.

Bubbles are usually formed during the production of the lubricant and as well as during the filling of the lubricant into the lubricant reservoir 2. When the bubbles pass through the lubricant supply hole 104 and merge to increase the sizes thereof in the slide channel 102, the lubricant can not be discharged effectively by the plunger 5. At this time, referring to FIG. 4, in order to discharge the bubbles through the gas-discharging hole 105 and the exhaust hole 6011, the plug 602 is pushed down to change the exhaust valve 6 from a closed state shown in FIG. 3 to an open state shown in FIG. 4. However, since the slide channel 102 and the lubricant supply hole 104 are not connected directly to the gas-discharging hole 105, it is difficult to discharge the bubbles within the slide channel 102 and the lubricant supply hole 104 effectively even upon repeated pushing of the plug 602. Therefore, the bubbles in the slide channel 102 and the lubricant supply hole 104 will cause idle operation of the lubricant gun and will have an adverse affect on discharging of the lubricant. Eventually, it is required to refill the lubricant to solve the problem attributed to the bubbles.

### SUMMARY OF THE INVENTION

Therefore, the object of the present invention is to provide a lubricant gun which can overcome the aforesaid shortcomings of the prior art.

The lubricant gun according to this invention includes a housing, a lubricant reservoir, a plunger, and an exhaust valve. The housing includes a discharge spout, a slide channel fluidly communicated with the discharge spout, a lubricant supply passage having a lubricant supply hole fluidly connected to the slide channel, and a gas-discharging hole fluidly communicated with the slide channel. The lubricant reservoir is connected to the housing and is fluidly communicated with the slide channel through the lubricant supply passage and the lubricant supply hole. The plunger has a pushing portion received in the slide channel for sliding reciprocatingly therein. The exhaust valve is mounted on the housing and is fluidly communicated with the gas-discharging hole.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional lubricant gun;

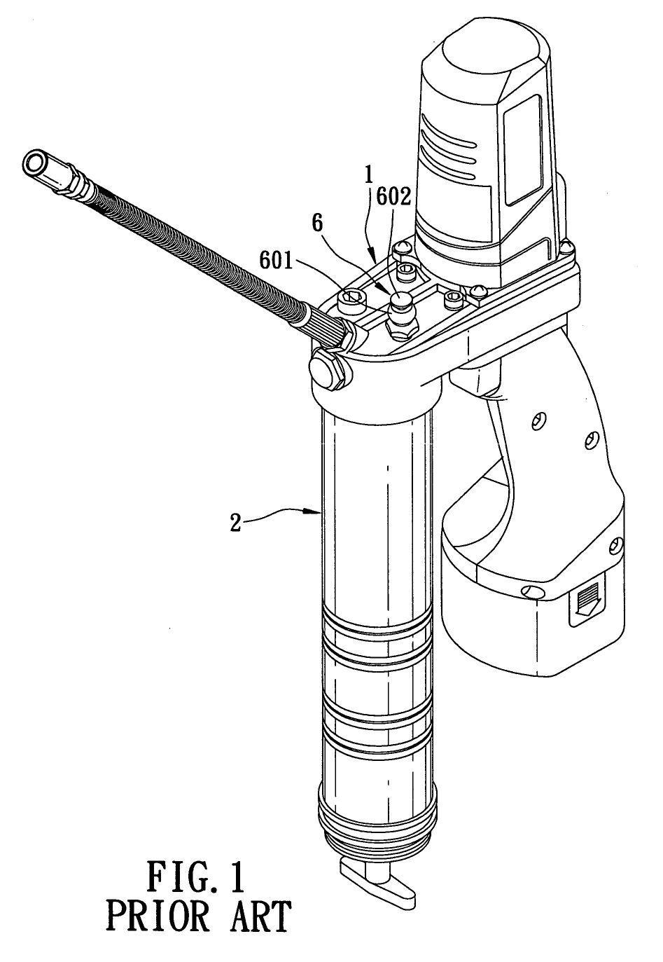

FIG. 2 is a fragmentary sectional view of the lubricant gun shown in FIG. 1;

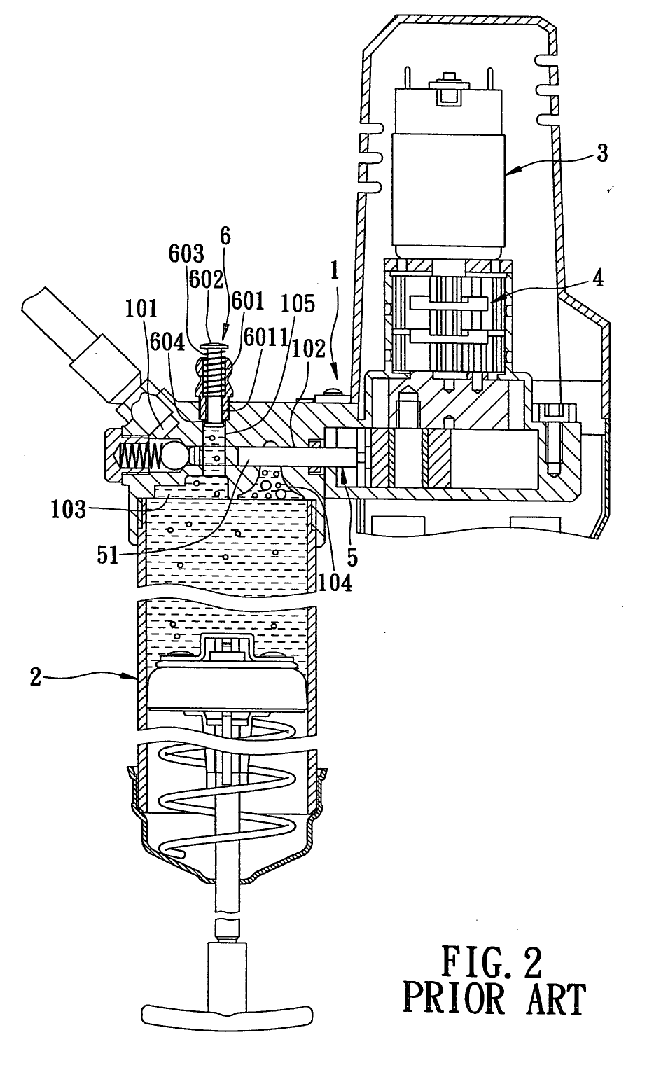

FIG. 3 is another fragmentary sectional view of the lubricant gun shown in FIG. 1 to show a state in which an exhaust valve is closed;

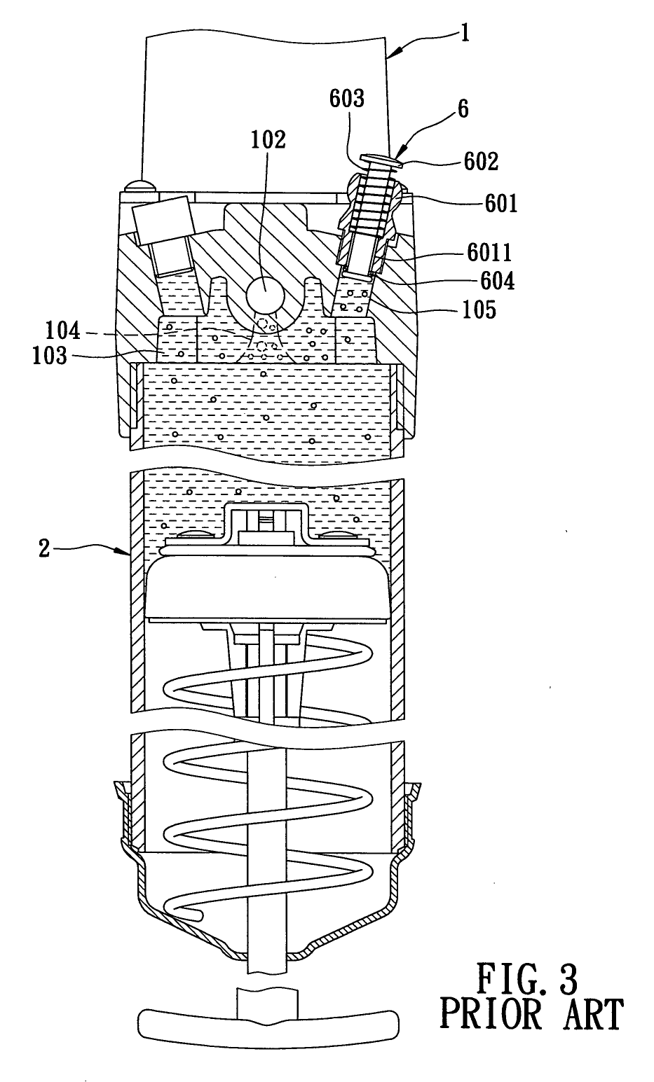

FIG. 4 is a fragmentary sectional view similar to FIG. 3 to show a state in which the exhaust valve is opened;

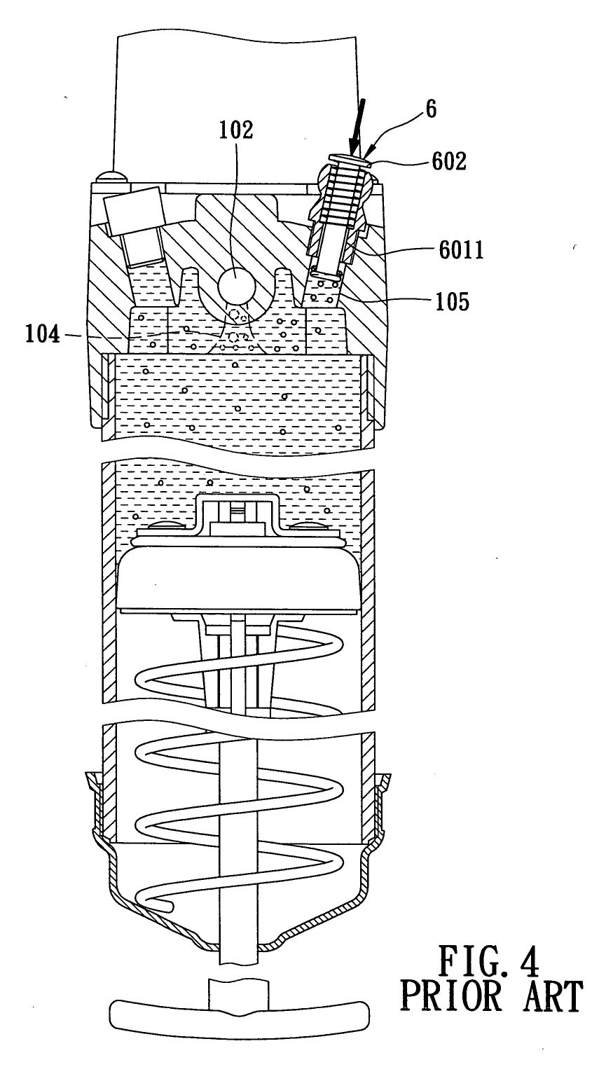

FIG. 5 is a perspective view of the preferred embodiment of a lubricant gun according to this invention;

FIG. 6 is a fragmentary schematic sectional view of the preferred embodiment;

FIG. 7 is another fragmentary schematic sectional view of the preferred embodiment to show a state in which an exhaust valve is closed;

FIG. 8 is yet another fragmentary schematic sectional view of the preferred embodiment to show a lubricant inlet fluidly communicated with a lubricant supply passage; and

FIG. 9 is a fragmentary schematic sectional view similar to FIG. 7 to show a sate in which the exhaust valve is opened.

### DETAILED DESCRIPTION OF THE PREFERRED EMBODIMENT

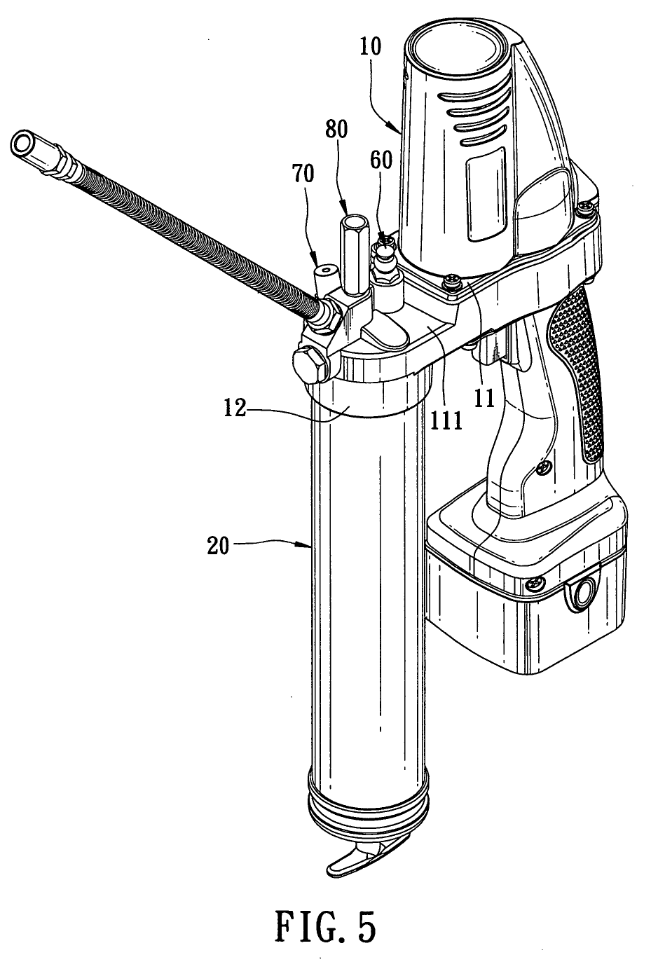

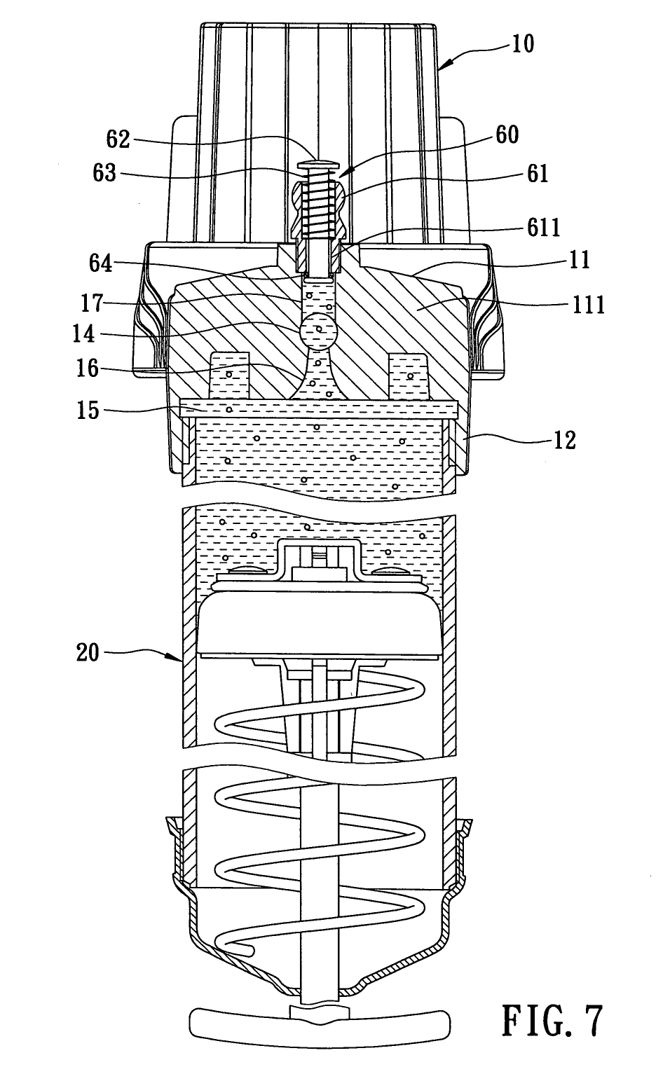

Referring to FIGS. 5, 6, and 7, the preferred embodiment of a lubricant gun according to this invention is shown to include a housing 10, a lubricant reservoir 20, a motor 30, a power transmission 40, a plunger 50, an exhaust valve 60, a lubricant inlet 70, and a safety valve 80.

The housing 10 includes a gun compartment 11 having a front portion 111 and a surrounding wall 12 at a bottom of the front portion 111, a discharge spout 13 mounted on the front portion 111, a slide channel 14 extending in the front portion 111 along a longitudinal direction (x) and fluidly communicated with the discharge spout 13, a lubricant supply passage 15 defined by the front portion 111 and the surrounding wall 12 and having a lubricant supply hole 16 fluidly connected to the slide channel 14 in a transverse direction (y) transverse, or preferably perpendicular, to the longitudinal direction (x), and a gas-discharging hole 17 fluidly communicated with the slide channel 14 in the transverse direction (y). The lubricant supply hole 16 and the gas-discharging hole 17 extend transversely of the slide channel 14 at two opposite sides of the slide channel 14, and are substantially aligned in the transverse direction (y). Therefore, the gas-discharging hole 17 is fluidly communicated with the lubricant supply hole 16 in the transverse direction (y) via the slide channel 14.

The lubricant reservoir 20 is connected to the surrounding wall 12 of the housing 10, and is fluidly communicated with the slide channel 14 through the lubricant supply passage 15 and the lubricant supply hole 16.

The motor 30 is mounted within the housing 10 for driving the plunger 50, via the power transmission 40, to slide reciprocatingly in the slide channel 14.

The power transmission 40 has a planet gear unit 41 driven by the motor 30, a final driver 42 actuated by the planet gear unit 41, and a connecting shaft 43 interconnecting the final driver 42 and the plunger 50.

The plunger 50 is driven by the power transmission 40, and has a pushing portion 51 facing toward the discharge spout 13 and received in the slide channel 14 for sliding reciprocatingly therein.

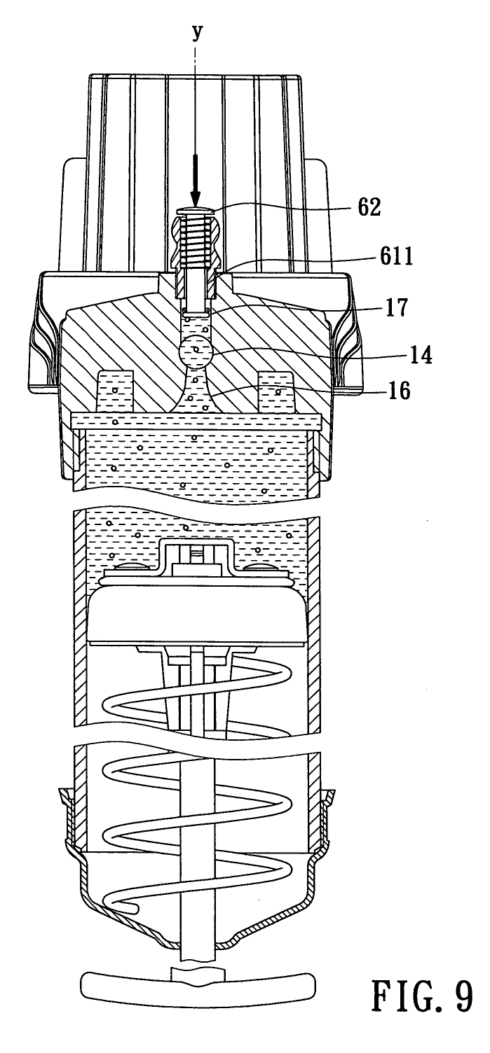

The exhaust valve 60 is mounted on the front portion 111 of the housing 10, and is fluidly communicated with the gas-discharging hole 17. The exhaust valve 60 includes a hollow valve body 61 mounted on the front portion 111 of the housing 10 and defining an exhaust hole 611 communicated with the gas-discharging hole 17, a plug 62 mounted movably within the exhaust hole 611 and loaded with a spring 63, and a leak-proof ring 64 attached to the bottom of the plug 62. Referring to FIG. 9, when the plug 62 is pushed downward, the exhaust hole 611 can be fluidly communicated with the gas-discharging hole 17. Therefore, the bubbles in the lubricant can be discharged from the exhaust hole 611 through the lubricant supply passage 15, the lubricant supply hole 16, the slide channel 14, and the gas-discharging hole 17 sequentially.

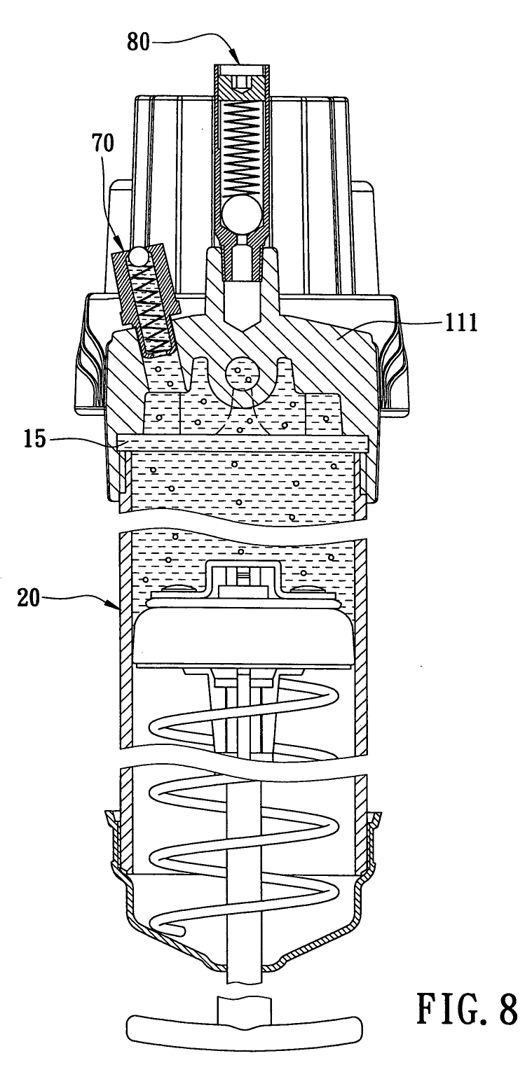

Referring to FIG. 8, the lubricant inlet 70 is mounted on the front portion 111 of the housing, and is fluidly communicated with the lubricant supply passage 15. The lubricant can be supplied into the lubricant reservoir 20 through the lubricant inlet 70.

The safety valve 80 is mounted on the front portion 111 of the housing 10, and is fluidly communicated with the discharge spout 13. When the pressure within the discharge spout 13 is above a predetermined value, the lubricant in the discharge spout 13 can be discharged through the safety valve 80.

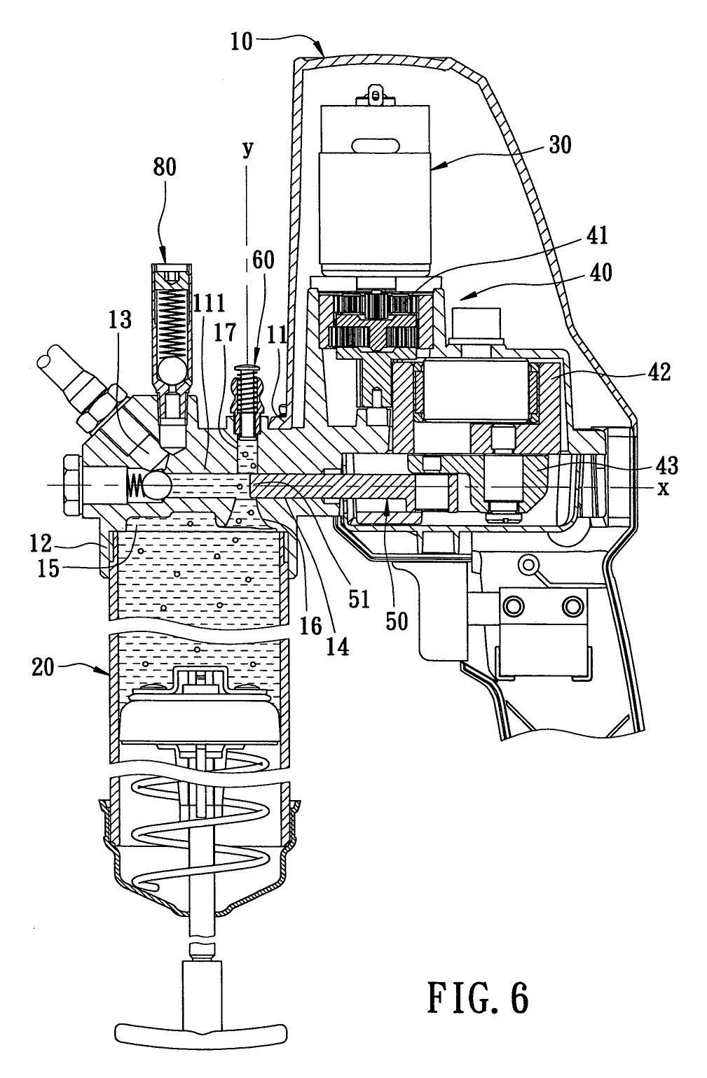

Referring again to FIG. 9, as described above, when the plug 62 is pushed downward, the exhaust hole 611 can be fluidly communicated with the gas-discharging hole 17. Therefore, the lubricant supply hole 16 and the slide channel 14 can be fluidly communicated with the exhaust hole 611 through the gas-discharging hole 17. The bubbles in the lubricant supply hole 16 and the slide channel 14 can be discharged immediately and effectively from the exhaust hole 611 through the gas-discharging hole 17 so as to prevent the bubbles from gathering in the lubricant supply hole 16 and the slide channel 14. Referring to FIG. 6, when the plunger 50 is driven by the power transmission 40 that is actuated by the motor 30, the pushing portion 51 of the plunger 50 can slide reciprocatingly in the slide channel 14 to discharge continuously the lubricant through the discharge spout 13 without encountering the aforesaid idle operation that is a shortcoming of the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A lubricant gun, comprising:
a housing including a discharge spout, a slide channel fluidly communicated with said discharge spout, a lubricant supply passage having a lubricant supply hole fluidly connected to said slide channel, and a gas-discharging hole fluidly communicated with said slide channel;
a lubricant reservoir connected to said housing and fluidly communicated with said slide channel through said lubricant supply passage and said lubricant supply hole;
a plunger having a pushing portion received in said slide channel for sliding reciprocatingly therein; and
an exhaust valve mounted on said housing and fluidly communicated with said gas-discharging hole.

2. The lubricant gun as claimed in claim 1, wherein said exhaust valve includes a hollow valve body mounted on said housing and defining an exhaust hole communicated with said gas-discharging hole, a plug mounted movably within said exhaust hole and loaded with a spring, and a leak-proof ring attached to said plug.

3. The lubricant gun as claimed in claim 1, further comprising a motor mounted within said housing for driving said plunger to slide reciprocatingly in said slide channel.

4. The lubricant gun as claimed in claim 1, further comprising a lubricant inlet mounted on said housing and fluidly communicated with said lubricant supply passage.

5. The lubricant gun as claimed in claim 1, further comprising a safety valve mounted on said housing and fluidly communicated with said discharge spout.

6. The lubricant gun as claimed in claim 1, wherein said lubricant supply hole and said gas-discharging hole extend transversely of said slide channel at two opposite sides of said slide channel and are substantially aligned in a direction transverse to said slide channel.
